(19) United States
(12) Patent Application Publication
(10) Pub. No.: US 2008/0259393 A1
(43) Pub. Date: Oct. 23, 2008

(54) IMAGE FORMING APPARATUS AND RECORDING MEDIUM

(76) Inventors: Saori IURA, Tokyo (JP); Toshiya Suzuki, Kawasaki-shi (JP); Michiaki Nishinosono, Tokyo (JP); Nobuhiro Shindo, Tokyo (JP); Yutaka Matsumoto, Saitama-shi (JP); Takeshi Yoshizumi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/104,720

(22) Filed: Apr. 17, 2008

(30) Foreign Application Priority Data
Apr. 23, 2007 (JP) 2007-113064

(51) Int. Cl. G06K 15/00

(52) U.S. Cl. 358/1.15

(57) ABSTRACT

An image forming apparatus, including a plurality of applications each including a reception unit configured to receive print data, a determination unit configured to analyze the print data received by the reception unit to determine the data format thereof, and a print control unit configured to print an image of print data having a specific data format. The print data analyzed by the determination unit is sent to the print control unit when the data format is determined to be equivalent to the specific data format, or another reception unit when the data format is determined to be different from the specific data format.

### CROSS-REFERENCE TO RELATED APPLICATIONS

The present patent application is based on and claims priority under 35 U.S.C. §119 from Japanese Patent Application No. 2007-113064, filed on Apr. 23, 2007 in the Japan Patent Office, the entire contents of which are incorporated herein by reference.

### BACKGROUND OF THE INVENTION

1. Field of the Invention

Exemplary aspects of the present invention generally relate to an image forming apparatus including a plurality of applications which may print data each having different data formats, and a recording medium storing a program used in the image forming apparatus. With such an image forming apparatus, the print data may be printed by using the plurality of the applications regardless of the data format of the print data.

2. Description of the Background

One example of a related-art image forming apparatus is a digital multifunction apparatus having two or more of copying, printing, and facsimile functions to digitalize image data. In addition, a digital multifunction apparatus further having an Internet facsimile function (hereinafter “i-FAX function”) has been provided along with the spread of the Internet in recent years.

The digital multifunction apparatus having the i-FAX function includes an image reading device, an image forming device, a facsimile communication device, a LAN connection device, and so forth. In the above-described digital multifunction apparatus, the copying function forms an image based on image data of an original document read by the image reading device. The facsimile function sends the image data of the original document read by the image reading device to a public network from the facsimile communication device, and forms an image based on the image data received by the facsimile communication device. The printing function prints an image based on the image data sent from a personal computer (hereinafter “PC”) on the LAN. The i-FAX function converts, for example, the image data read by the image reading device into a TIFF file, to send the image data as a file attached to electronic mail (hereinafter “e-mail”) to the Internet through a mail server on the LAN, and receives an e-mail having a message and an attached file from the mail server to form an image based on image data of the message and the attached file.

During operation of the copying, facsimile, printing, and i-FAX functions, units including software and hardware respectively having a copying application, a facsimile application, a printing application, and an i-FAX application, are operated.

The image forming device is configured to interpret a predetermined or desired printing format which is an image forming command described in a predetermined or desired print control program language called a page description language, and to generate bitmap data to form an image. Accordingly, when performing printing based on a print instruction specified by a user, each of the above-described applications converts the image data to be sent to the image forming device into a predetermined or desired print format. For example, the printing application converts the image data in a file format formed by a word processing program or a spreadsheet program installed in the PC into a predetermined or desired print format. Similarly, the i-FAX application converts a message and an attached file included in an e-mail into a predetermined or desired print format.

Another example image forming device further includes a printing module having a function of directly converting image data into a predetermined or desired print format into bitmap data as well as a function of converting image data described in a predetermined or desired print format into bitmap data. With such a printing module, each of the above-described applications can convert print data in a predetermined or desired file format or print format into bitmap data to print the print data.

However, for example, in a case in which a file attached to an e-mail has a data format, a file format, or a print format which may not be printable by the printing module in the i-FAX application, a print error occurs even when the printing module in the printing application can print the file. Consequently, the user is required to recognize which application can print which data format, and to select an appropriate application for printing that data format in order to prevent the print error, causing inconvenience to the user.

### SUMMARY

In view of the foregoing, exemplary embodiments of the present invention provide an image forming apparatus including a plurality of applications capable of printing files each having different data formats. With such an image forming apparatus, the files may be printed by using the plurality of the applications regardless of the data format of the files.

In one exemplary embodiment, an image forming apparatus includes a plurality of applications each including a reception unit configured to receive print data, a determination unit configured to analyze the print data received by the reception unit to determine a data format thereof, and a print control unit configured to print an image of print data having a specific data format. The print data analyzed by the determination unit is sent either to the print control unit when the data format is determined to be equivalent to the specific data format or to another reception unit when the data format is determined to be different from the specific data format.

Another exemplary embodiment provides a computer-readable recording medium storing a program to operate an image forming apparatus including a reception unit configured to receive print data; a determination unit configured to analyze the print data received by the reception unit to determine a data format thereof; and a print control unit configured to print an image of print data having a specific data format. The print data analyzed by the determination unit is sent either to the print control unit, when the data format is determined to be equivalent to the specific data format, or to another reception unit, when the data format is determined to be different from the specific data format.

Additional features and advantages of the present invention will be more fully apparent from the following detailed description of exemplary embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description of exemplary embodiments when considered in connection with the accompanying drawings, wherein:

FIG. 1 is a schematic view illustrating an image forming apparatus according to a first exemplary embodiment and a network system including the image forming apparatus;

FIG. 2 is a schematic view illustrating system software installed in the image forming apparatus 1 illustrated in FIG. 1;

FIG. 3 is a schematic view illustrating modules for receiving data in a printing application and an i-FAX application illustrated in FIG. 2;

FIG. 4 is a flowchart illustrating processing steps in modules in a printing application and an i-FAX application of an image forming apparatus according to a second exemplary embodiment;

FIG. 5 is a flowchart illustrating a subroutine of an analysis step in FIG. 4;

FIG. 6 is a schematic view illustrating operation of modules in an image forming apparatus according to a third exemplary embodiment;

FIG. 7 is a schematic view illustrating operation of modules in an image forming apparatus according to a fourth exemplary embodiment;

FIG. 8 is a schematic view illustrating operation of modules in an image forming apparatus according to a fifth exemplary embodiment;

FIG. 9 is a schematic view illustrating operation of modules in an image forming apparatus according to a sixth exemplary embodiment;

FIG. 10 is a schematic view illustrating operation of modules in an image forming apparatus according to a seventh exemplary embodiment;

FIG. 11 is a schematic view illustrating operation of modules in an image forming apparatus according to an eighth exemplary embodiment; and

FIG. 12 is a schematic view illustrating operation of modules in an image forming apparatus according to a ninth exemplary embodiment.

### DETAILED DESCRIPTION OF EXEMPLARY EMBODIMENTS

It will be understood that if an element or layer is referred to as being “on,” “against,” “connected to” or “coupled to” another element or layer, then it can be directly on, against connected or coupled to the other element or layer, or intervening elements or layers may be present.

In contrast, if an element is referred to as being “directly on”, “directly connected to” or “directly coupled to” another element or layer, then there are no intervening elements or layers present. Like numbers refer to like elements throughout.

As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures.

For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms.

These terms are used only to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

Exemplary embodiments of the present invention are now described below with reference to the accompanying drawings.

In a later-described comparative example, exemplary embodiment, and exemplary variation, for the sake of simplicity the same reference numerals will be given to identical constituent elements such as parts and materials having the same functions and redundant descriptions thereof omitted unless otherwise stated.

Typically, but not necessarily, paper is the medium from which is made a sheet on which an image is to be formed. It should be noted, however, that other printable media are available in sheets, and accordingly their use here is included. Thus, solely for simplicity, although this Detailed Description section refers to paper, sheets thereof, paper feeder, etc., it should be understood that the sheets, etc., are not limited only to paper but includes other printable media as well.

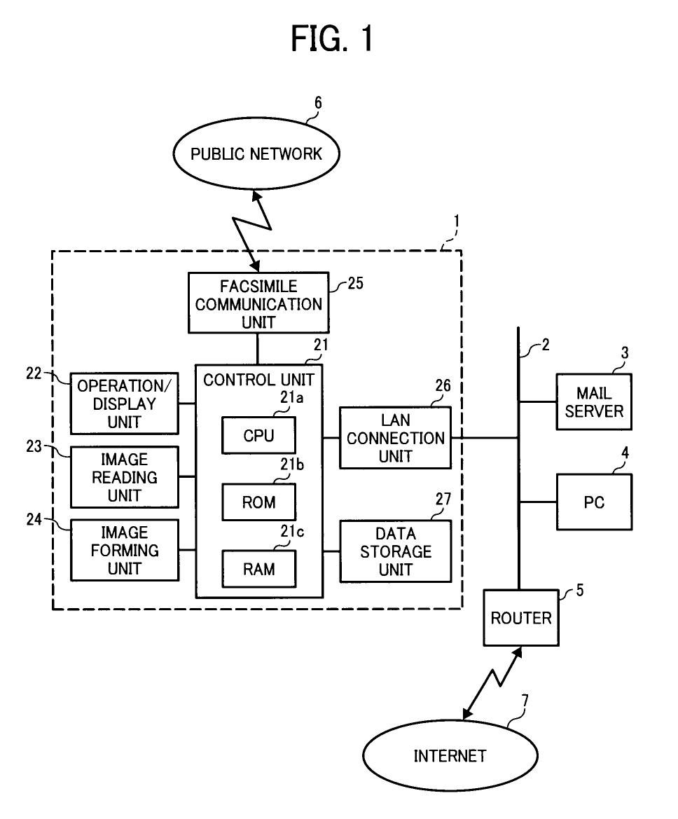

FIG. 1 is a schematic view illustrating an image forming apparatus according to a first exemplary embodiment and a network system including the image forming apparatus. The network system includes an image forming apparatus 1, a LAN 2, a mail server 3, a PC 4, and a router 5. Each of the image forming apparatus 1, the mail server 3, the PC 4, and the router 5 is connected to the LAN 2. The image forming apparatus 1 is connected to an analog or a digital public network 6, and the router 5 is connected to the Internet 7.

The image forming apparatus 1 includes a control unit 21 including a CPU 21a, a ROM 21b, and a RAM 21c. The image forming apparatus 1 further includes an operation/display unit 22, an image reading unit 23, an image forming unit 24, a facsimile communication unit 25, a LAN connection unit 26, and a data storage unit 27, each of which is connected to the control unit 21.

The control unit 21 controls each unit in the image forming apparatus 1, and performs computation. The operation/display unit 22 includes an operation part having keys for operating the image forming apparatus 1, such as numeric keys, a start key, and function keys; and a display part including a liquid crystal display (LCD) or the like, for displaying an operational state of the image forming apparatus 1, data input through a key in the operation part, and so forth. The image reading unit 23 reads an image from an original document, and outputs the read image as image data. The image forming unit 24 prints the image on a sheet or the like based on the image data. The facsimile communication unit 25 exchanges facsimile image data with a destination communication device on the public network 6. The LAN connection unit 26 exchanges data with each device on the LAN 2. The data storage unit 27 includes a high-capacity storage device such as a hard disk device and stores a variety of data.

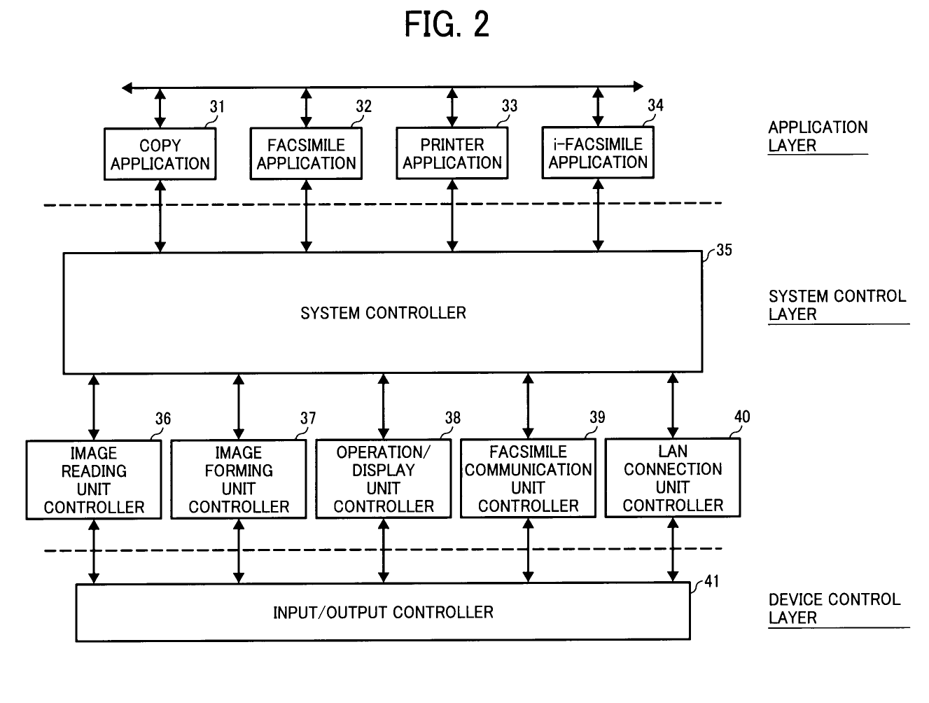

FIG. 2 is a schematic view illustrating system software installed in the image forming apparatus 1 illustrated in FIG. 1. The image forming apparatus 1 includes a multitasking operating system, and each function of the units such as the operation/display unit 22 is treated as a resource. A system control layer manages the image forming apparatus 1 such that a single resource is shared by a plurality of applications. The system control layer includes a system controller 35 to control the image forming apparatus 1. The system control layer further includes an image reading unit controller 36, an image forming unit controller 37, an operation/display unit controller 38, a facsimile communication unit controller 39, and a LAN connection unit controller 40, each of which is controlled by the system controller 35. A device control layer includes an input and output controller 41 for receiving signals from sensors and sending signals to clutches, motors, and other units to actually operate such units in response to commands, control signals and other logical instructions from the system control layer. An application layer includes a copying application 31, a facsimile application 32, a printing application 33, and an i-FAX application 34.

The above-described applications coexist in the application layer by virtue of functions provided from the system control layer. Each application is configured to be connected to all units in the image forming apparatus 1 as a unit including software and hardware for performing a function thereof. Moreover, each application is configured to receive and send print data from and to the system controller 35.

Operation of each of copying, facsimile, printing, and i-FAX functions in the image forming apparatus 1 with the above-described configuration is described in detail below.

When a user uses the copying function of the image forming apparatus 1, first, the copying application 31 is operated, and the image reading unit 23 reads image data from an original document. Subsequently, the control unit 21 processes the image data in a predetermined or desired manner, and thereafter, the image forming unit 24 prints an image based on the image data. In place of the control unit 21, an image processing device may be used for processing the image data.

When a facsimile is sent by using the facsimile function of the image forming apparatus 1, first, the facsimile application 32 is operated, and the image reading unit 23 reads image data from an original document. Subsequently, the control unit 21 encodes the image data in a predetermined or desired manner, and thereafter, the facsimile communication unit 25 sends the image data thus encoded to a destination facsimile terminal or the like connected to the public network 5. When a facsimile is received, first, the control unit 21 decodes facsimile image data received by the facsimile communication unit 25, and thereafter, the image forming unit 24 prints an image based on the image data thus decoded. In place of the control unit 21, an encoding and decoding device may be used for encoding and decoding the image data.

When data formed by the PC 4 is printed by using the printing function of the image forming apparatus 1, first, the printing application 33 is operated, and print data which is image data for printing sent from the PC 4 is input into the control unit 21 via the LAN connection unit 26. Thereafter, the image forming unit 24 prints an image based on the print data sent from the PC 4.

When image data attached to an e-mail is sent by using the i-FAX function of the image forming apparatus 1, first, the i-FAX application 34 is operated, and the image reading unit 23 reads image data from an original document. Subsequently, the control unit 21 converts the image data into a TIFF file format, and the image data thus converted is attached to a message in the e-mail generated by the control unit 21. After being sent to the mail server 3 through the LAN connection unit 26 and temporarily stored in the mail server 3, the e-mail is sent from the router 5 to the Internet 7. When image data attached to an e-mail is received by using the i-FAX function of the image forming apparatus 1, first, the control unit 21 accesses the mail server 3 for each predetermined or desired time to check whether or not an e-mail sent to the image forming apparatus 1 is stored. When the e-mail is stored in the mail server 3, the control unit 21 downloads the e-mail and separates an attached data file from a message in the e-mail. Thereafter, the image forming unit 24 prints an image based on image data of the attached data file.

A description is now given of reception in the printing application 33 and the i-FAX application 34.

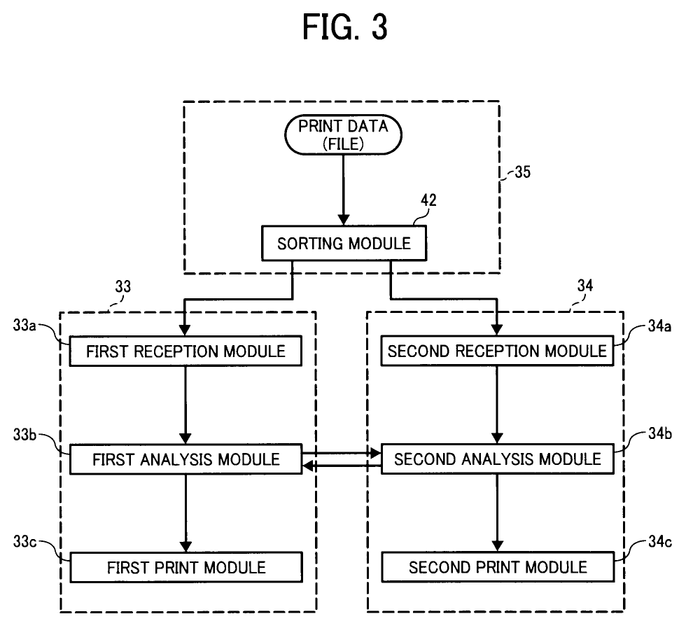

FIG. 3 is a schematic view illustrating modules for receiving data in the printing application 33 and the i-FAX application 34. The printing application 33 includes a first reception module 33a, a first analysis module 33b, and a first printing module 33c. The i-FAX application 34 includes a second reception module 34a, a second analysis module 34b, and a second printing module 34c. A sorting module 42 provided in the system controller 35 sorts print data sent from the PC 4 and the mail server 3 to appropriately send the print data to either the first reception module 33a or the second reception module 34a. A destination of the print data is determined based on a first data format of the print data.

The first reception module 33a and the second reception module 34a respectively send the print data received from the sorting module 42 to the first analysis module 33b and the second analysis module 34b for each predetermined amount of print data. The first analysis module 33b and the second analysis module 34b respectively analyze the data format of the print data and determine whether or not the data format can be printed by the first printing module 33c and the second printing module 34c. When determining that the data format cannot be printed by the first printing module 33c and the second printing module 34c, respectively, the first analysis module 33b and the second analysis module 34 respectively forward the print data to the other analysis module. In other words, when determining that the data format cannot be printed by the first printing module 33c, the first analysis module 33b forwards the print data to the second analysis module 34b. Meanwhile, when determining that the data format cannot be printed by the second printing module 34c, the second analysis module 34b forwards the print data to the first analysis module 33b. On the other hand, when determined that the data format can be printed by the first printing module 33c and the second printing module 34c, respectively, the first analysis module 33b and the second analysis module 34b respectively set print parameters based on the print data, and respectively send the print parameters to the first printing module 33c and the second printing module 34c together with the print data.

An example of a printing module, print parameters, and a printing method is shown below in Table 1. In Table 1, the first printing module 33c corresponds to XX, and the second printing module 34c corresponds to YY. In other words, the first printing module 33c directly converts print data in PDF format and PS (PostScript (registered trademark)) format into bitmap data to print an image of the print data, and the second printing module 34c directly converts the print data in TIFF format and PCL format into bitmap data to print an image of the print data. Therefore, when receiving the print data in the TIFF format from the first reception module 33a, the first analysis module 33b forwards the print data to the second analysis module 34b so that the second printing module 34c can print an image of the print data. Similarly, when receiving the print data in the PDF format from the second reception module 34a, the second analysis module 34b forwards the print data to the first analysis module 33b so that the first printing module 33c can print an image of the print data. At this time, the first analysis module 33b or the second analysis module 34b to which the print data is forwarded performs the operation by using a storage area in the RAM 21c storing the print data analyzed by the first analysis module 33b or the second analysis module 34b which forwards the print data.

TABLE 1

| Item | |
|---|---|
| Printing Module | XX: PDF and PS formats can be printed. |
| | YY: TIFF and PCL formats can be printed. |
| Print Parameters | Paper Size: A4 |
| | Color: Cyan, magenta, yellow, and black. |
| Printing Method | Combine print data into one file. |

The first printing module 33c and the second printing module 34c respectively receive the print data and the set print parameters from the first analysis module 33b and the second analysis module 34b, and respectively send the print data and the set parameters to the image forming unit controller 37 to control printing in the image forming unit 24. A printing method is set by the user in advance, and the print data to which the printing method is added is sent to the first reception module 33a and the second reception module 34a from the sorting module 42.

As described above, according to the first exemplary embodiment, the print data can be forwarded between the first analysis module 33b and the second analysis module 34b. As a result, when respectively determining that the first printing module 33c and the second printing module 34c cannot print an image of the print data in a predetermined or desired format respectively received from the first reception module 33a and the second reception module 34a, the first analysis module 33b and the second analysis module 34b respectively forward the print data to the other analysis module so that the image can be printed by the printing module to which the print data is forwarded. Therefore, an image can be printed by using the printing application 33 and the i-FAX application 34 regardless of printing functions thereof.

A description is now given of a second exemplary embodiment of the present invention. Configurations of the image forming apparatus 1 according to the second exemplary embodiment and system software installed therein are the same as those of the image forming apparatus according to the first exemplary embodiment and the system software installed therein. However, in the second exemplary embodiment, when each of the first printing module 33c and the second printing module 34c cannot print the data format of the print data respectively received from the first reception module 33a and the second reception module 34a, the first analysis module 33b and the second analysis module 34b respectively forward the print data to the other analysis module together with an analysis module search table shown below in Table 2.

TABLE 2

| | | Analysis Module | | | | |
|---|---|---|---|---|---|---|
| Item | | First | Second | Third | Fourth | . . . |
| Determination | Initial State | — | — | — | — | — |
| Result | After | X | — | — | — | — |
| | Determination | | | | | |
| | by First | | | | | |
| | Analysis Module | | | | | |
| | After | X | ◯ | — | — | — |
| | Determination | | | | | |
| | by Second | | | | | |
| | Analysis Module | | | | | |

◯: Printable
X: Unprintable
—: Not yet determined

The analysis module search table includes a determination result indicating whether or not each print module can print the data format of the print data.

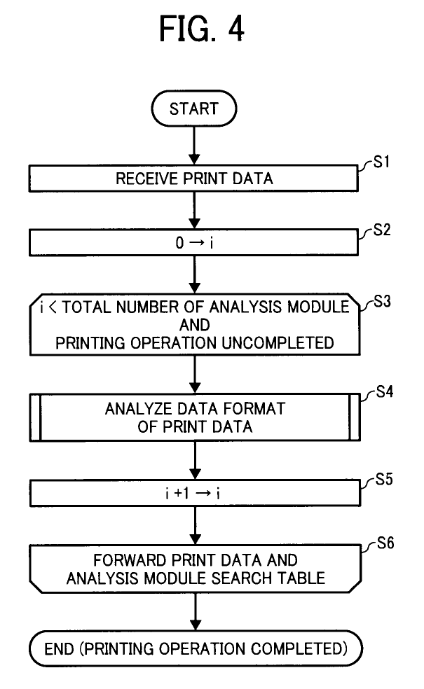

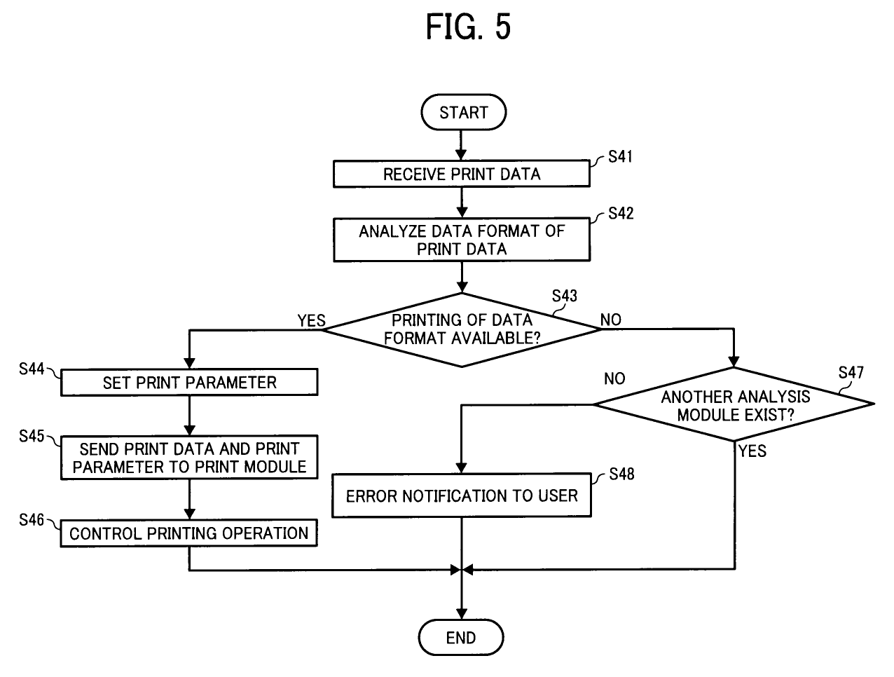

FIG. 4 is a flowchart illustrating processing steps in the modules in the printing application 33 and the i-FAX application 34 in the image forming apparatus 1 according to the second exemplary embodiment. FIG. 5 is a flowchart illustrating a subroutine in an analysis step at S4 in FIG. 4. In addition to the configurations of the image forming apparatus 1 and the system software installed therein, a configuration of the modules in the printing application 33 and the i-FAX application 34 according to the second exemplary embodiment is also same as that of the modules in the printing application 33 and the i-FAX application 34 according to the first exemplary embodiment.

Referring to FIG. 4, when the control unit 21 receives the print data, the sorting module 42 sorts the print data and sends the print data to an appropriate reception module at S1. Subsequently, an analysis process counter, not shown, sets a count value i to zero at S2. When the count value i is smaller than a total number of analysis modules, for example, the total number of the analysis modules is two in FIG. 3, and printing operation is not yet completed, the count value i is repeatedly increased each time the analysis module analyzes the print data from S3 to S6. “Printing operation completed” shown at the end of the flowchart in FIG. 4 indicates a case in which printing of the print data is completed or error handling is performed because printing cannot be performed. In FIG. 4, S2 is performed by the sorting module 42, and S3 through S6 are performed by the analysis module.

As illustrated in FIG. 5, when the print data is analyzed, the appropriate analysis module illustrated in FIG. 3 receives the print data at S41 and analyzes the data format of the print data at S42. Next, at S43, the analysis module determines whether or not a printing module belonging to the same application can print the data format of the print data thus analyzed. When determining that the printing module can print the data format (YES at S43), the analysis module sets print parameters at S44, and sends data indicating the print data and the print parameters to the printing module at S45. At S46 the printing module controls printing according to the received data.

On the other hand, when determining that the printing module cannot print the data format of the print data (NO at S43), at S47 the analysis module determines whether or not another analysis module in which the above-described determination is not yet performed exists. When another analysis module does not exist (No at S47), at S48 the analysis module sends an error notification to the user. On the other hand, when another analysis module exists (YES at S47), the analysis module inputs data indicating that the printing module belonging to the same application cannot print the data format into a column for the analysis module in the analysis module search table, and finishes the processing. For example, when the first printing module 33c cannot print the data format of the print data received from the first reception module 33a, the first analysis module 33b inputs data of “Unprintable (X)” into a column of the determination result for the first analysis module 33b as shown in Table 2.

When the processing illustrated in FIG. 5 is finished at “YES at S47,” the process proceeds to S5 in FIG. 4. Accordingly, the count value i in the analysis counter is increased at S5, and the analysis module, for example, the first analysis module 33b, forwards the print data and the analysis module search table to another analysis module, for example, the second analysis module 34b, at S6. Thereafter, the process returns to S3, and proceeds to S4 to perform the analysis step as illustrated in FIG. 5 again. In an example to be described below, the second analysis module 34b analyzes the print data.

When determining that the second printing module 34c can print the data format of the received print data, the second analysis module 34b sets print parameters at S44, and sends data indicating the print data and the set print parameters to the second printing module 34c at S45. In addition, the second analysis module 34b inputs data of “Printable (O)” into a column for the second analysis module 34b in the analysis module search table as shown in Table 2.

On the other hand, when determining that the second printing module 34c cannot print the data format of the received print data (NO at S43), the second analysis module 34b performs the same processes as those of the first analysis module 33b described above.

Therefore, according to the second exemplary embodiment, the analysis module receives the analysis module search table together with the print data from another analysis module so that the analysis module can determine which printing module cannot print the data format of the received print data. As a result, when determining that the printing module belonging to the same application cannot print the data format of the received print data, the analysis module can appropriately determine a destination analysis module to forward the print data.

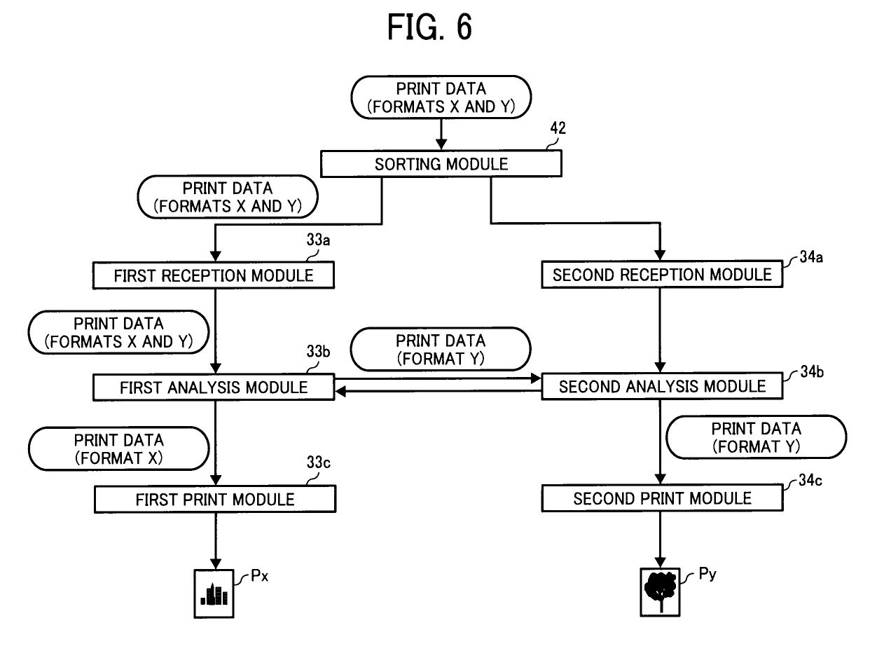

A description is now given of a third exemplary embodiment of the present invention. Configurations of the image forming apparatus 1 according to the third exemplary embodiment and system software installed therein are the same as those of the image forming apparatus according to the first exemplary embodiment and the system software installed therein. However, the print data includes two sets of data in different data formats. FIG. 6 is a schematic view illustrating operation of modules in the image forming apparatus 1 according to the third exemplary embodiment.

As illustrated in FIG. 6, the print data includes two sets of data respectively having data formats X and Y. The data in the data format X is included first in the print data, and is followed by the data in the data format Y. Here, the data format X means the PDF format or the PS format, and can be printed by the first printing module 33c. The data format Y means the TIFF format or the PCL format, and can be printed by the second printing module 34c.

Referring to FIG. 6, when receiving the print data, the sorting module 42 reads a predetermined or desired amount of data from the received print data to analyze the print data. When determining that the data in the data format X is included first in the print data, the sorting module 42 appropriately determines that the print data in the data format X needs to be sent to the first analysis module 33b which is provided corresponding to the first printing module 33c capable of printing the data format X. Thus, the sorting module 42 sends the print data to the first reception module 33a.

The print data sent to the first reception module 33a is further sent to the first analysis module 33b. When detecting the data in the data format Y which cannot be printed by the first printing module 33c in the received print data, the first analysis module 33b separates the data in the data format Y from the print data. In addition, the first analysis module 33b inputs a determination result indicating that the first printing module 33c cannot print the data format Y into a column for the data format Y in the analysis module search table, and forwards the separated print data in the data format Y and the analysis module search table with the above-described determination result to the second analysis module 34b.

After respectively setting print parameters for the print data in the formats X and Y, the first analysis module 33b and the second analysis module 34b respectively send the print data with the set print parameters to the first printing module 33c and the second printing module 34c. The first printing module 33c and the second printing module 34c respectively control printing of the print data according to the set print parameters. As a result, the image forming unit 24 outputs images Px and Py.

When the data format Y cannot be printed by the second printing module 34c, the second analysis module 34b inputs a determination result indicating that the data format Y cannot be printed by the second printing module 34c into a column for the second printing module 34c in the analysis module search table, and forwards the print data in the data format Y and the analysis module search table to another analysis module in which determination is not yet performed.

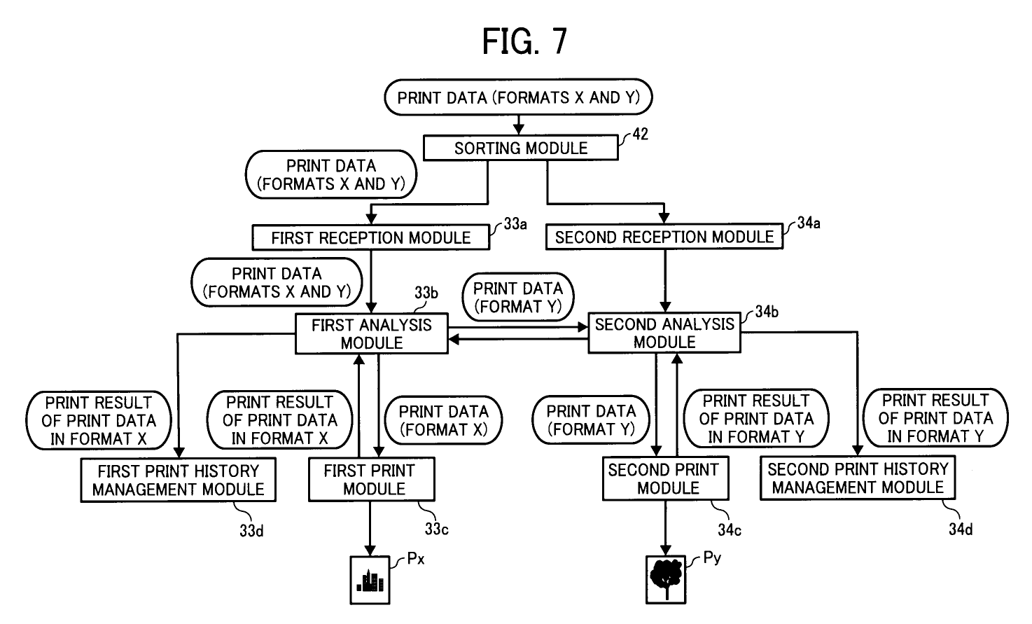

A description is now given of a fourth exemplary embodiment of the present invention. Configurations of the image forming apparatus 1 according to the fourth exemplary embodiment and system software installed therein are the same as those of the image forming apparatus according to the first exemplary embodiment and the system software installed therein. FIG. 7 is a schematic view illustrating operation of modules in the image forming apparatus 1 according to the fourth exemplary embodiment. In FIG. 7, processes from the start to the process in which the first printing module 33c and the second printing module 34c respectively control printing of the print data in the data formats X and Y are the same as those according to the third exemplary embodiment. However, according to the fourth exemplary embodiment, a module for managing a print history for each printing module is provided.

The first printing module 33c and the second printing module 34c respectively send a print result to the first analysis module 33b and the second analysis module 34b. The first analysis module 33b and the second analysis module 34b respectively send the received print result to a first print history management module 33d corresponding to the first printing module 33c and a second print history management module 34d corresponding to the second printing module 34c. The first print history management module 33d and the second print history management module 34d respectively store the received print result.

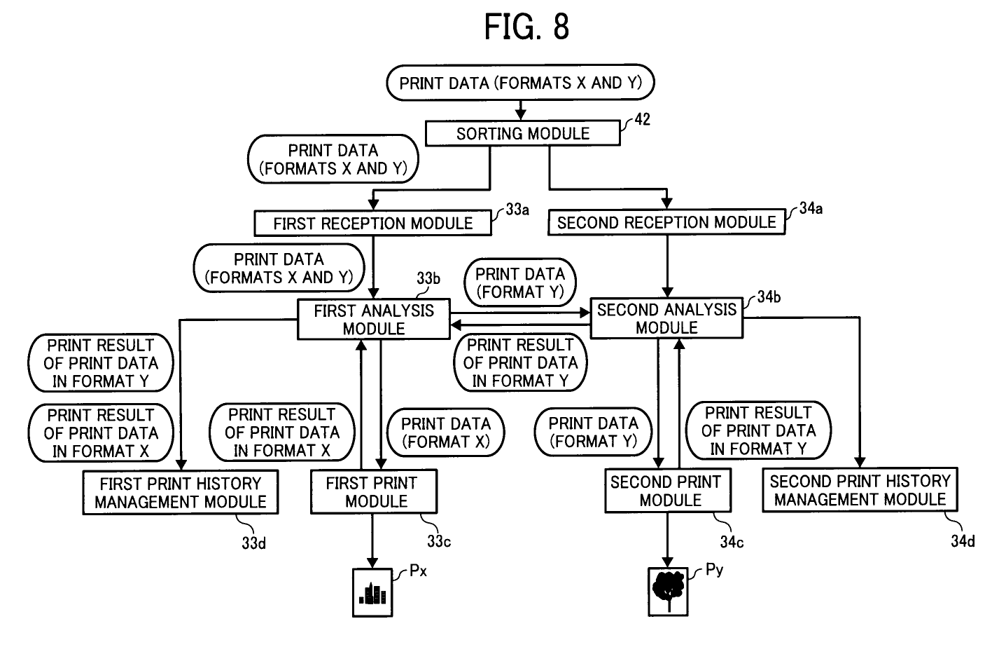

A description is now given of a fifth exemplary embodiment of the present invention. Configurations of the image forming apparatus 1 according to the fifth exemplary embodiment and system software installed therein are the same as those of the image forming apparatus according to the first exemplary embodiment and the system software installed therein. FIG. 8 is a schematic view illustrating operation of modules in the image forming apparatus 1 according to the fifth exemplary embodiment. In FIG. 8, processes from the start to the process in which the first analysis module 33b and the second analysis module 34b respectively receive the printing result from the first printing module 33c and the second printing module 34c are the same as those according to the fourth exemplary embodiment.

According to the fifth exemplary embodiment, the first analysis module 33b sends the print result received from the first printing module 33c to the first print history management module 33d in the same way as in the fourth exemplary embodiment described above. Meanwhile, the second analysis module 34b sends the print result received from the second print module 34c to the first print history management module 33d via the first analysis module 33b, instead of sending the print result to the second print history management module 34d. The first print history management module 33d stores the two print results received from the first analysis module 33b as a print history of a single print job, for each of the first printing module 33c and the second printing module 34c, and for each data format.

Therefore, according to the fifth exemplary embodiment, the first print history management module 33d corresponding to the first printing module 33c for controlling printing of the print data based on the print data sent from the first analysis module 33b which first receives the print data stores and manages the print results of all data formats of the print data.

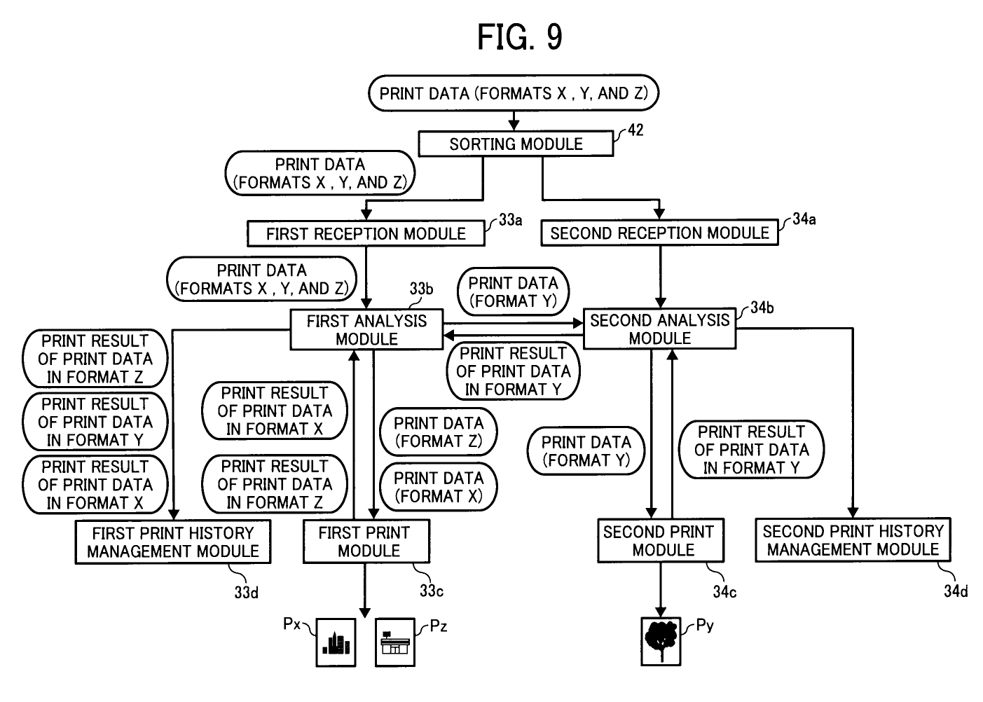

A description is now given of a sixth exemplary embodiment of the present invention. Configurations of the image forming apparatus 1 according to the sixth exemplary embodiment and system software installed therein are the same as those of the image forming apparatus according to the first exemplary embodiment and the system software installed therein. FIG. 9 is a schematic view illustrating operation of modules in the image forming apparatus 1 according to the sixth exemplary embodiment. In the sixth exemplary embodiment, the print data includes data in three different data formats X, Y, and Z.

As described above, referring to FIG. 9, the print data includes the data in the data formats X, Y, and Z. The data in the data format X is included first in the print data, is followed by the data in the data format Y, and is further followed by the data in the data format Z.

Processing steps performed for the print data in the formats X and Y according to the sixth exemplary embodiment are the same as those according to the fifth exemplary embodiment. In the sixth exemplary embodiment, the first printing module 33c can print the format Z in addition to the format X by converting the print data in the format Z into bitmap data. As a result, the first printing module 33c sequentially control printing of the print data in the formats X and Z, and the image forming unit 24 outputs images Px and Pz. The first printing module 33c sends the print history of the print data in the formats X and Z to the first print history management module 33d via the first analysis module 33b. Similarly to the fifth exemplary embodiment, the first print history management module 33d receives the print history also from the second printing module 34c, and stores the three print histories thus received as a print history for a single print job for each of the first printing module 33c and the second printing module 34c, and for each data format.

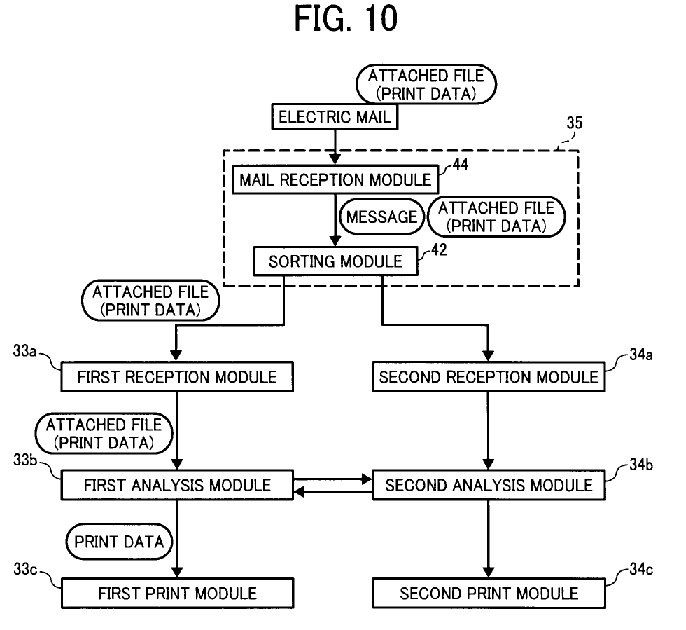

A description is now given of a seventh exemplary embodiment of the present invention. Configurations of the image forming apparatus 1 according to the seventh exemplary embodiment and system software installed therein are the same as those of the image forming apparatus according to the first exemplary embodiment and the system software installed therein. FIG. 10 is a schematic view illustrating operation of modules in the image forming apparatus 1 according to the seventh exemplary embodiment. In the seventh exemplary embodiment, the system controller 35 further includes a mail reception module 44 to separate a received e-mail into a message and an attached file, and send the message and the attached file to the sorting module 42.

Referring to FIG. 10, the sorting module 42 reads a predetermined or desired amount of data from the attached file received from the mail reception module 44, and analyzes the data format of the attached file. After analyzing the data format of the attached file, the sorting module 42 appropriately determines that print data of the attached file needs to be sent to the first analysis module 33b provided corresponding to the first printing module 33c capable of printing the data format thus analyzed. Accordingly, the sorting module 42 sends the attached file to the first reception module 33a.

The attached file sent to the first reception module 33a is further sent to the first analysis module 33b, and the first analysis module 33b analyzes the data format of the attached file. When determining that the data format of the attached file can be printed by the first printing module 33c, the first analysis module 33b sets print parameters, and sends the print parameters to the first printing module 33c together with the print data. The first printing module 33c controls printing of the attached file according to the print parameters. As a result, the image forming unit 24 outputs an image of the attached file.

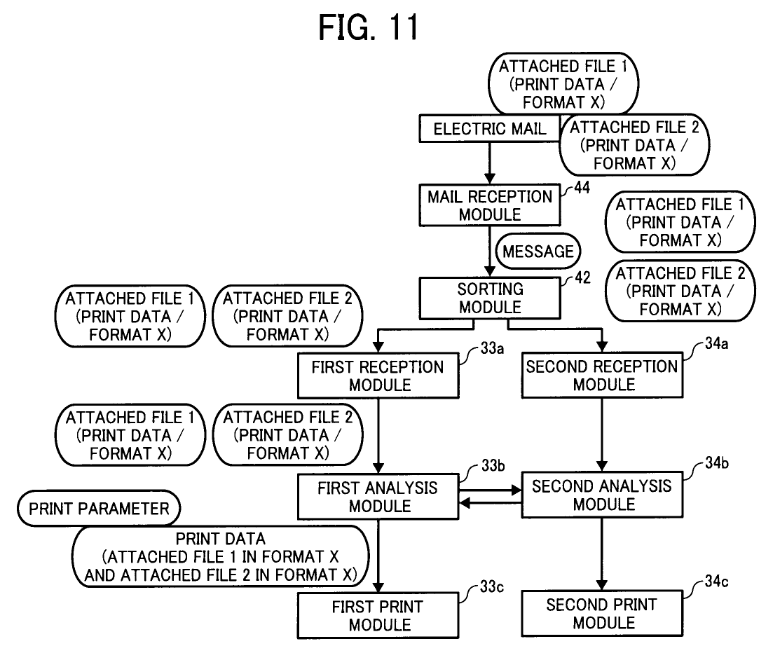

A description is now given of an eighth exemplary embodiment of the present invention. FIG. 11 is a schematic view illustrating operation of modules in the image forming apparatus 1 according to the eighth exemplary embodiment. In the eight exemplary embodiment, reference numerals same as those in the seventh exemplary embodiment are given to modules same as, or corresponding to, the modules according to the seventh exemplary embodiment. According to the eighth exemplary embodiment, two files in the data format X are attached to an e-mail.

Referring to FIG. 11, when receiving the e-mail having attached files 1 and 2, the mail reception module 44 separates the received e-mail into a message and the attached files 1 and 2, and sends the message and the attached files 1 and 2 to the sorting module 42. The sorting module 42 reads a predetermined or desired amount of data from the attached file 1 which is a first file included in the e-mail, and analyzes the data format of the attached file 1. Because the attached file 1 includes the data format X, the sorting module 42 appropriately determines that the attached file 1 needs to be sent to the first reception module 33a provided corresponding to the first printing module 33c capable of printing the data format X. Therefore, the sorting module 42 sends the attached file 1 to the first reception module 33a. The attached file 1 sent to the first reception module 33a is further sent to the first analysis module 33b. The same processing steps described above are performed for the attached file 2, so that the attached file 2 is also sent to the first analysis module 33b.

The first analysis module 33b sequentially determines print parameters for each of the attached files 1 and 2 based on the print data thereof, and sets the print parameters for both the attached files 1 and 2. Thereafter, the first analysis module 33b sends the print parameters for the attached files 1 and 2 to the first printing module 33c together with the print data.

The first printing module 33c sequentially control printing of the attached files 1 and 2 according to the print parameters received from the first analysis module 33b. As a result, the image forming unit 24 sequentially outputs images of the attached files 1 and 2. An example of the data formats, the print parameters, and the printing method is shown in Table 3 below.

TABLE 3

| Item | |
|---|---|
| Format | X: PDF and PS formats |
| | Y: TIFF and PCL formats |
| Print | (Attached File 1) |
| Parameters | Paper Size: A4 |
| | Color: Black |
| | (Attached File 2) |
| | Paper Size: A3 |
| | Color: Cyan, magenta, yellow, and black |
| Printing Method | Attached file: Input for each file (print |
| | data). |

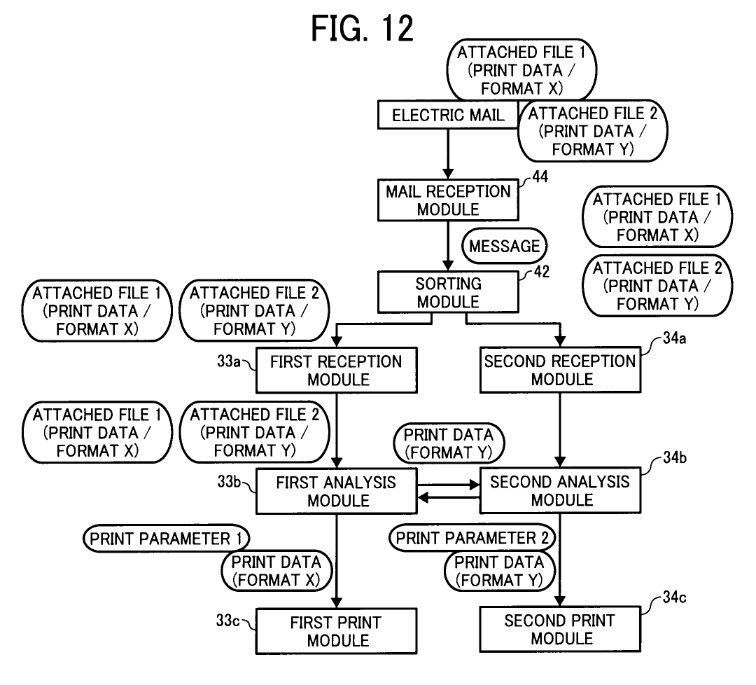

A description is now given of an ninth exemplary embodiment of the present invention. FIG. 12 is a schematic view illustrating operation of modules in the image forming apparatus 1 according to the ninth exemplary embodiment. In the ninth exemplary embodiment, reference numerals same as those in the seventh exemplary embodiment are given to modules same as, or corresponding to the modules according to the seventh exemplary embodiment. In the ninth exemplary embodiment, a file in the data format X and a file in the data format Y are attached to an e-mail, and processes from the start to the process in which the first reception module 33a receives the attached files 1 and 2 are the same as the processes according to the seventh exemplary embodiment.

The first analysis module 33b sequentially analyzes the print data of the attached files 1 and 2 sent from the first reception module 33a. When determining that the first printing module 33c can print the attached file 1 in the data format X and cannot print the attached file 2 in the data format Y, the first analysis module 33b separates the attached file 2 from the attached file 1. In addition, the first analysis module 33b inputs a determination result indicating that the first printing module 33c cannot print the data format Y into the analysis module search table for the data format Y; and forwards the attached file 2, the analysis module search table with the above-described determination result, and data indicating that the first analysis module 33b is the first analysis module which determines that the first printing module 33c cannot print the data format Y, to the second analysis module 34b.

The second analysis module 34b analyzes the print data of the attached file 2, and determines that the second printing module 34c can print the attached file 2 in the data format Y. In a case in which the second printing module 34c cannot print the data format Y, the second analysis module 34b refers to the analysis module search table for the data format Y, and forwards the print data for the attached file 2 and the analysis module search table for the data format Y to another analysis module which does not yet analyze the print data for the attached file 2. At the same time, the second analysis module 34b inputs a determination result indicating that the second printing module 34c cannot print the data format Y into the analysis module search table. The second analysis module 34b also forwards data indicating that the second analysis module 34b is the second analysis module which determines whether or not the data format Y can be printed by the second printing module 34c to the another analysis module.

The first analysis module 33b and the second analysis module 34b respectively set the print parameters for each print data for the attached files 1 and 2, and respectively send the print parameters to the first printing module 33c and the second printing module 34c together with the print data. The first printing module 33c and the second printing module 34c respectively control printing of the print data according to the print parameters. As a result, the image forming unit 24 sequentially outputs images of the attached files 1 and 2.

The first printing module 33c may send a print result to the first analysis module 33b, and the first analysis module 33b may further send the print result to the first print history management module 33d, not shown in FIG. 12, so that the print result may be stored in the first print history management module 33d. In addition, the second printing module 34c may send a print result to the second analysis module 34b, and the second analysis module 34b may send the print result to the first analysis module 33b after referring to the data indicating that the first analysis module 33b is the first analysis module which determines whether or not the data format Y can be printed by the first printing module 33c received from the first analysis module 33b. Accordingly, the first analysis module 33b may send the print result to the first print history management module 33d, and the print result may be stored in the first print history management module 33d. The first print history management module 33d combines the print results for the attached files 1 and 2, and stores the combined print results indicating completion of printing as a print history for the e-mail received by the image forming apparatus 1.

In the exemplary embodiments described above, the analysis module determines the data format of the print data to set the print parameters of the print data. Alternatively, the analysis module may set the print parameters of the print data based on settings specified by the user. Moreover, although the print data is forwarded between the printing application 33 and the i-FAX application 34 in the forgoing exemplary embodiments, the print data may be forwarded among a plurality of applications as long as each of the plurality of the applications can print different formats. Furthermore, although the i-FAX application 34 in which an image data is attached to an e-mail is described in the forgoing exemplary embodiments, the present invention is applicable to an i-FAX application in which an image data is encoded and sent in a form of packets.

Elements and/or features of different exemplary embodiments may be combined with each other and/or substituted for each other within the scope of this disclosure and appended claims.

Example embodiments being thus described, it will be obvious that the same may be varied in many ways. Such exemplary variations are not to be regarded as a departure from the spirit and scope of the present invention, and all such modifications as would be obvious to one skilled in the art are intended to be included within the scope of the following claims.

The number of constituent elements, locations, shapes and so forth of the constituent elements are not limited to any of the structure for performing the methodology illustrated in the drawings.

What is claimed is:

1. An image forming apparatus, comprising a plurality of applications each comprising:
a reception unit configured to receive print data;
a determination unit configured to analyze the print data received by the reception unit to determine a data format thereof; and
a print control unit configured to print an image of print data having a specific data format,
wherein the print data analyzed by the determination unit is sent to the print control unit when the data format is determined to be equivalent to the specific data format, or another reception unit when the data format is determined to be different from the specific data format.

2. The image forming apparatus according to claim 1, further comprising a sorting unit configured to receive the print data and send the print data to one of the reception units of the plurality of applications.

3. The image forming apparatus according to claim 2, wherein the sorting unit determines a destination reception unit to send the print data based on a first data format of the print data.

4. The image forming apparatus according to claim 1, wherein the print data comprises a plurality of print data each having different data formats, and the determination unit independently analyzes each of the plurality of print data to determine a data format thereof.

5. The image forming apparatus according to claim 1, further comprising at least one print history storage unit configured to store print histories of the plurality of print control units.

6. The image forming apparatus according to claim 5, wherein the at least one print history storage unit comprises a plurality of print history storage units provided corresponding to the plurality of print control units.

7. The image forming apparatus according to claim 6, wherein a print history storage unit provided corresponding to a print control unit which prints the print data first stores the print histories of all of the plurality of print control units.

8. The image forming apparatus according to claim 6, wherein each of the print history storage units stores the print history of the corresponding print control unit.

9. The image forming apparatus according to claim 7, wherein print histories of print control units other than the print control unit which prints the print data first are forwarded to the print history storage unit provided corresponding to the print control unit which prints the print data first.

10. The image forming apparatus according to claim 5, wherein the print data comprises a plurality of print data each having different data formats, and the print history storage unit independently stores each of the print histories corresponding to each of the plurality of print data.

11. The image forming apparatus according to claim 5, wherein the print data comprises a plurality of print data each having different data formats, and the print history storage unit stores a combined print history in which the print histories corresponding to the plurality of print data are combined.

12. The image forming apparatus according to claim 2, further comprising an e-mail reception unit configured to receive an e-mail comprising a message and an attached file comprising a print data, and send the message and the attached file to the sorting unit.

13. The image forming apparatus according to claim 12, wherein the print data comprises a plurality of print data, and the determination unit sets a single print parameter to the plurality of print data, considered as single print data.

14. The image forming apparatus according to claim 13, wherein the determination unit sets the single print parameter based on a first print data.

15. The image forming apparatus according to claim 12, wherein the print data comprises a plurality of print data, and the determination unit sets a plurality of print parameters each corresponding to the plurality of print data.

16. The image forming apparatus according to claim 13, further comprising a print history storage unit configured to store a single print result comprising print results of the plurality of print data.

17. The image forming apparatus according to claim 13, further comprising a print history storage unit configured to store a plurality of print results each corresponding to the plurality of print data.

18. A computer-readable recording medium storing a program to operate an image forming apparatus comprising:
a reception unit configured to receive print data;
a determination unit configured to analyze the print data received by the reception unit to determine a data format thereof; and
a print control unit configured to print an image of print data having a specific data format,
wherein the print data analyzed by the determination unit is sent to the print control unit when the data format is determined to be equivalent to the specific data format, or to another reception unit when the data format is determined to be different from the specific data format.
